(19) United States
(12) Patent Application Publication
(10) Pub. No.: US 2002/0187462 A1
(43) Pub. Date: Dec. 12, 2002

(54) Internet based teaching system

(76) Inventor: Jawaharlal Mariappan, Sewell, NJ (US)

Correspondence Address: BLANK ROME COMISKY & MCCAULEY, LLP, 900 17TH STREET, N.W., SUITE 1000, WASHINGTON, DC, 20006, US

(21) Appl. No.: 09/784,082

(22) Filed: Feb. 16, 2001

(51) Int. Cl. G09B 3/00

(52) U.S. Cl. 434/350

(57) ABSTRACT

The present invention provides for an Internet based teaching system. This educational tool is divided into three grade levels of elementary school, middle school, and high school. After selecting the grade level, the student has the option of selecting among various activities, including classroom, homework, portfolio, fun activities, friends, and gallery, which are all designed to be appropriate for the grade level selected. The classroom activity includes tutorials and exercises to help the student attain his educational goals.

### BACKGROUND OF THE INVENTION

Education is the largest business in the United States after health care and has been left largely untouched by Internet companies during the growth of the Internet. In the United States alone, kindergarten through twelfth (K-12) grade education has the potential to command more than 60 million users.

Traditionally, students wishing to supplement their school studies have to hire tutors or buy books and study independently. Both these methods have drawbacks. Hiring tutors is expensive and determining the quality of the tutor is difficult. Buying books is also expensive and the student generally has to go through large amounts of material to locate the exact topic being studied. This is a frustrating process and often leads to the student wasting time and not learning the desired material.

The present invention provides parents and their children with a healthy and quality online educational experience using an interactive medium that allows the user to quickly and easily locate any subject. The invention assists public, private and home-schooled students to attain their educational goals by providing curriculum based, original scholastic content.

### SUMMARY AND OBJECTS OF THE INVENTION

In view of the foregoing, it is apparent that there still exists a need for a well organized, easy to navigate, educational website which provides the user with a quick and efficient means of locating a subject.

It is an object of this invention to deliver the full K-12 curriculum over the Internet to individuals and institutions. The invention ultimately breaks learning objectives into bite-sized chunks that students can digest in a few minutes each. Students have access to tutorials, quizzes and exams to help them gain a comprehensive understanding of the subject matter.

A further object of the invention is to allow students to pace themselves and gauge their own progress. At every step, students interact with the educational material at their own pace, independently or with guidance from parents and teachers as they move through interactive tutorial sessions toward achieving their goal of mastering and expanding skills introduced in class, or to explore and learn in new areas.

It is still a further object of the invention to save instructors and teachers time by allowing them to assign homework and practice exams online that can be graded automatically. Instructors can also put other educational material online to provide students with a single source of information about the curriculum or other related topics.

It is a further object of the invention to allow parents to become involved in their children's learning by allowing them to assist their children to study online and to electronically track their progress.

It is a further object of this invention to provide a learning environment over the Internet in an easy-to-use and entertaining format so that the student enjoys the learning process. This is accomplished by using graphics and animation which allows the student to interact with the website.

The present invention consists of three separate organizational designs for a website targeting elementary (ages 5-10), middle school (ages 10-13), and high school (ages 13-18) students. The website contains several activities and its organization and design allows a student participating in one activity to quickly link to another activity. One of the more important activities is the classroom activity which contains the educational material within the website. The topics within the educational material are organized in a drop menu fashion so that they are readily displayed, easily understood, and the user can locate any subject with a few click of his mouse.

With these and other objects, advantages and features of the invention that may become hereinafter apparent, the nature of the invention may be more clearly understood by reference to the following detailed description of the invention, the appended claims and to the several drawings attached herein.

### BRIEF DESCRIPTION OF DRAWINGS

FIG. 1 is a schematic view of a home page of the present invention;

FIG. 1A is a pictorial view of the home page of FIG. 1;

FIG. 2 is a schematic view of a school page of the present invention;

FIG. 2A is a pictorial view of a high school page of FIG. 2;

FIG. 2B is a pictorial view of a middle school page of FIG. 2;

FIG. 3A is a pictorial view of a classroom activity page of the present invention;

FIG. 3B is a pictorial view of a portfolio activity page of the present invention;

FIG. 4 is a schematic view of a lesson page of the present invention;

FIG. 4A is a pictorial view of the lesson page of FIG. 4;

FIG. 5 is a schematic view of an exercise page of the present invention;

FIG. 5A is a pictorial view of the exercise page of FIG. 5; and

FIG. 6 is a schematic view of a global database system for the present invention.

### DETAILED DESCRIPTION OF THE PREFERRED EMBODIMENTS

With the burgeoning use of the Internet, parents, teachers and students are looking for high-quality, cost-effective alternatives to traditional methods of teaching. The web-based educational system of the present invention meets this need.

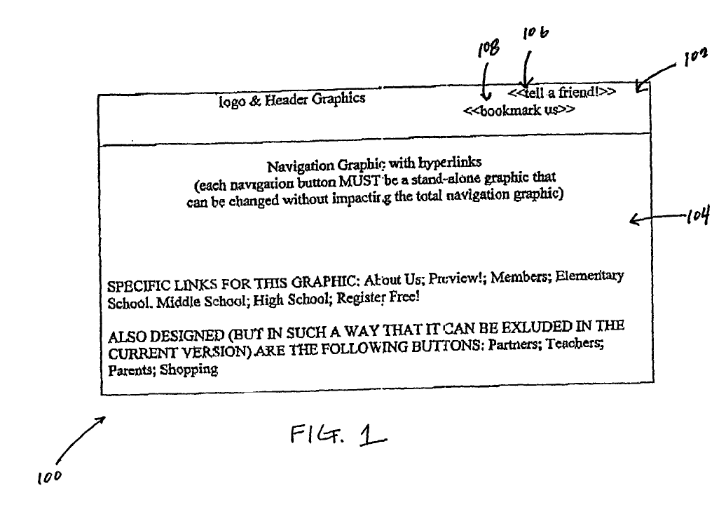

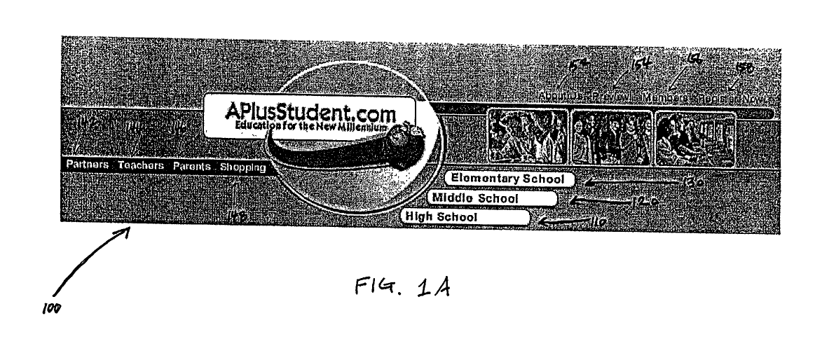

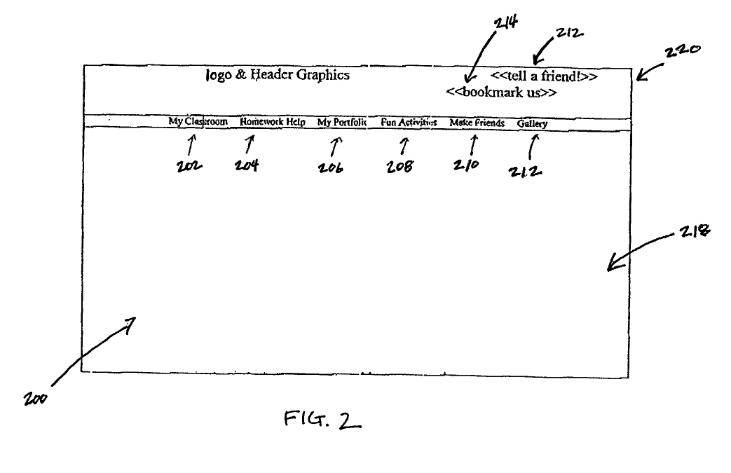

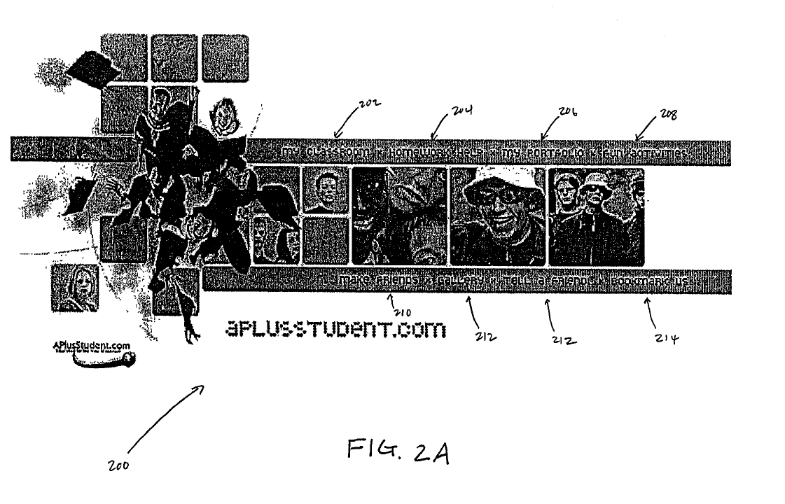

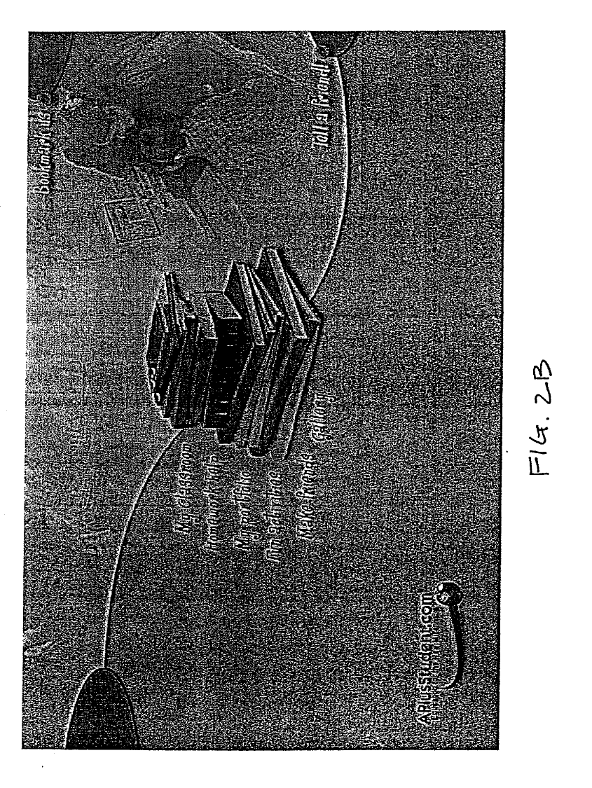

Initially, the user accesses the instant educational system by going to the home webpage 100, shown in FIGS. 1 and 1A, by using a computer connected to the Internet. FIG. 1 is a schematic view of the home page 100 which shows the layout of the page in general terms. FIG. 1A is a pictorial view of the home page and illustrates a preferred embodiment of how the page is displayed. It should be understood that while FIG. 1A is used to describe the present invention, it is merely an example of how the page might look and is not intended to limit the scope or breadth of the invention. Similarly, the pictorial views of FIGS. 2A, 2B, 3A, 3B, 4A, and 5A are provided to help illustrate and describe the present invention, and are not intended to limit its scope or breadth.

The home page 100 consists mostly of a large, rectangular content area 104 and a smaller header area 102 along the entire top portion of the page. It uses a simple, one click navigation system in which links to sub-sections are embedded in graphics contained in the header area 102 and the content area 104. The header area 102 contains various graphics and links of general interest, such as a corporate logo, a “tell a friend” icon 106 which allows the user to send an email invitation to a friend to join the service, and a “bookmark us” icon 108 which allows the user to quickly return to the home page 100 at a future time.

The content area 104 of the home page 100 contains icons which direct the user to various features on the website. The high school icon 110, middle school icon 120, and elementary school icon 130 are placed in the center of the content area 104 and link the user to the school page 200, described later. The home page further contains icons on the left side of the content area 104 which link to various features that may be of interest to those cooperating with the student to achieve his educational goals, for example, a parents icon 146, a teachers icon 144, and a partners icon 142. A shopping icon 148 is also provided and links to one or more webpages selling various educational and website related products to promote the students goals. On the right side of the content area are various icons which provide information regarding the educational website and include an “About Us” icon 152, a “Preview” icon 154, a “Members” icon 156, and a “Register Now!” icon 158.

The “About Us” icon 152 links the user to background information relating to the objectives and content of the website. The “Preview” icon 154 allows the user to visit various webpages within the system to examine the content and presentation of the educational material. The “Members” icon 156 links an already subscribed user to a login page where he is prompted to enter his login identification and password. The “Register Now!” icon 158 links the user to a registration page where he can enter his personal information into the system and creates an individual login identification. The login identification is used by the system to recognize and track the individual's activities while on the system.

The individual school icons 110, 120, and 130 link to a corresponding school page 200, shown in FIGS. 2, 2A and 2B. FIG. 2 is a schematic view of a generic school page and shows the layout of various features on the page. FIG. 2A is a pictorial view of a high school page and FIG. 2B is a pictorial view of a middle school page, both showing images of how the school page may be displayed. Although the description of the school page 200 is given, in part, in reference to the school page of FIGS. 2A and 2B, it should be understood that all three school pages have similar layouts and contain the same features. However, each school page 200 is distinguished from the other school pages by graphics, pictures, and other indicia which identify the page being viewed. For example, the high school page of FIG. 2A contains pictures of older teenagers, and specifically, shows a picture of students graduating from high school. This identifies the page as a high school page, and distinguishes it from the middle school and elementary school pages which have graphics, pictures, and other indicia appropriate for their respective ages and grades.

Each school page 200 is directed to students whose age and grade in a traditional school matches the school page. In other words, the elementary school page corresponds to grades 1-5, the middle school page corresponds to grades 6-8, and the high school page corresponds to grades 9-12 in a traditional school system. In that way the user is able to determine which school page is most appropriate by comparing his age and/or grade in a traditional school to that on the website. The preferred embodiment contains three school pages, but it is contemplated that other embodiments of the invention may contain more school pages.

The school page 200 comprises a large, rectangular content area 218 which encompasses the entire page, except the top portion which contains a header area 220. The content area 218 contains the several activity icons such as classroom 202, homework 204, portfolio 206, fun activities 208, friends 210 and gallery 212, which link to their respective activity pages. New activity icons can be added later, and current activity icons can be deleted depending on the demands of the user. The header 220 contains the educational system's logo and a “tell a friend” icon 212 and a “bookmark us” icon 214. Other miscellaneous icons can be placed in either the content area 218 or header area 220 to provide quick and easy links to other relevant pages, either within or even outside of the website.

As seen from FIGS. 2A and 2B, the icons in the content area 218 and the header 220 are combined with other graphics to present an attractive and easily understandable page. The activity icons are in the form of text links and are placed prominently in the content area 218 and are therefore easily located. The educational system's logo, the “tell a friend” icon and the “bookmark us” icon are placed on the page to fit within the overall layout of the page. That may or may not include placing those icons in the header 220 or in the content area 218 of the page 200.

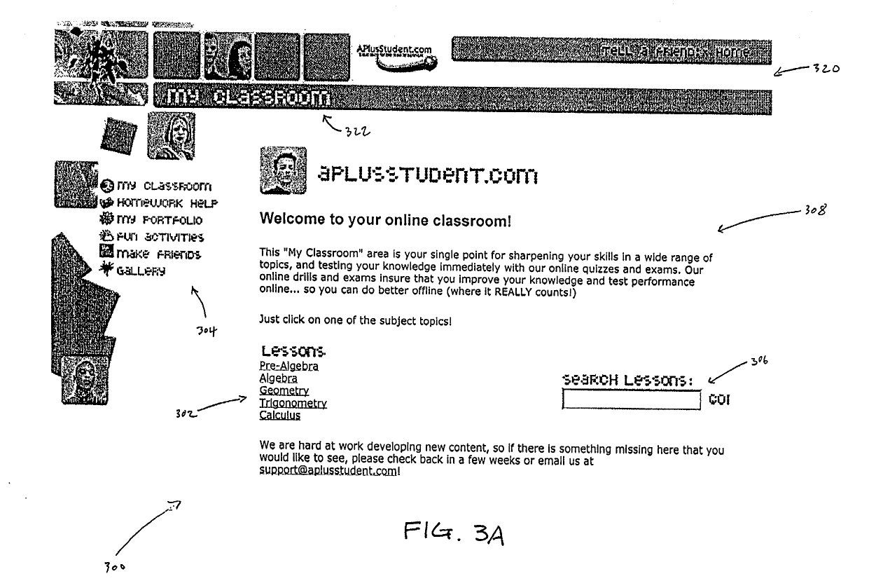

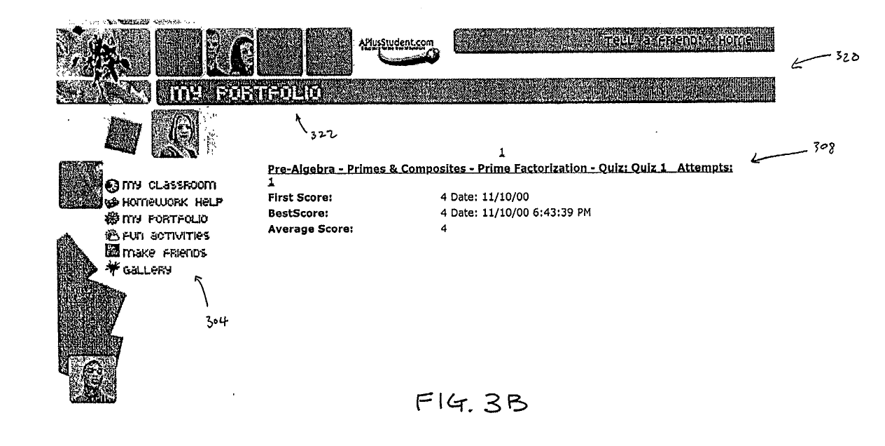

The school page 200 functions as a “kickoff” page to the educational website. It is from here that the user has the option of choosing from several activity icons and being quickly linked to that activity page. Each activity icon on the school page 200 is linked to its respective activity page. If the user wishes to study a particular subject, he can choose the classroom icon 202 and be linked to the classroom activity page 300, shown in FIG. 3A, which contains the educational material found on the website. If the user wishes to check on his progress through the tutorials, he can click the portfolio activity icon 206 and being linked to a report on his progress, shown in FIG. 3B.

Although the description of the activity page is given in reference to FIGS. 3A and 3B, each activity page has similar elements and the description provided below is applicable to all the activity pages.

Each activity page 300 contains an activity navigation bar 304 which lists all the activities available on the school page 200, and is normally placed along one of the sides of the page. In a preferred embodiment, shown in FIGS. 3A and 3B, it is along the left portion of the page. The activity navigation bar 304 of the activity page 300 enables a user who is viewing one activity page to quickly link to another, different activity page. The user can single click his computer mouse and link to a different activity page without having to backtrack through several webpages to arrive at the new activity.

The activity page 300 also includes a header along the top portion of the page, which includes the educational system's logo, a “tell a friend” icon and a “home” icon. Unlike previously described headers, the header 320 also includes the title 322 to the activity page currently being viewed. Therefore, if the classroom activity page is being viewed, then the title 322 will read “my classroom.”

The remainder of the page is a large content area 308 which contains the substantive material and any relevant links associated with the activity. For example, FIG. 3A shows the content area 308 for the classroom activity page with text information on the purpose of the page and links to lessons 302 which contain the educational tutorials. FIG. 3B shows a portfolio activity page and is identical to FIG. 3A except that its content area 308 contains a report on the past exams and quizzes taken by the student so that he can track his progress through the educational system of the present invention.

The other activity pages (not shown) have page layouts similar to that in FIGS. 3A and 3B. All the activity pages have an activity navigation bar 304, a header 320 and a content area 308. However, the content area 308 for each activity page contains information relevant to the particular activity page being viewed.

The functions of each of the respective activity pages will now be described. The homework icon 204 is linked to a homework activity page (not shown) that provides students assistance with their assignments and answers questions they may have. The homework activity page contains a list of subjects from which the student can choose. Once a subject is selected, the student is linked to a page containing answers to frequently asked questions. Questions for each subject are further organized by sub-topic (e.g. under the mathematics topic, sub-topics may include addition, subtraction, etc.). If an answer to a student's question is unavailable, he can submit his own question, which is sent as an email to trained personnel, who respond directly to an email address provided by the student.

The portfolio icon 206 is linked to a portfolio activity page, as shown by example in FIG. 3B, that displays all of the quizzes and tests taken by the student to date. This allows the student and his parents to track his progress as he advances through the tutorials and exercises provided in the present invention.

The fun activities icon 208 is linked to a fun activities page (not shown) which provides entertaining activities for the student tailored to the appropriate school level. For example, the fun activities page for the kindergarten grade level may include sliding puzzles, jigsaw puzzles and interactive coloring games.

The friends icon 210 is linked to a friends activity page (not shown) which allows the user to enter chat rooms and communicate with other users online.

The gallery icon 212 is linked to a gallery activity page (not shown) that displays artwork, poems, stories, and other works uploaded by students. An award system may be integrated into the gallery section, where students can submit their works to the gallery and prizes are awarded based on the works.

The classroom activity page 300 contains the educational and tutorial material provided for in the website. The content area 308 of the page contains links to lessons 302 which categorize the educational material into well known subjects such as Algebra, Geometry, and Calculus. If the user cannot locate the lesson he wishes to study, a search box 306 enables the user to type in a topic and search the entire website for information relating to that topic.

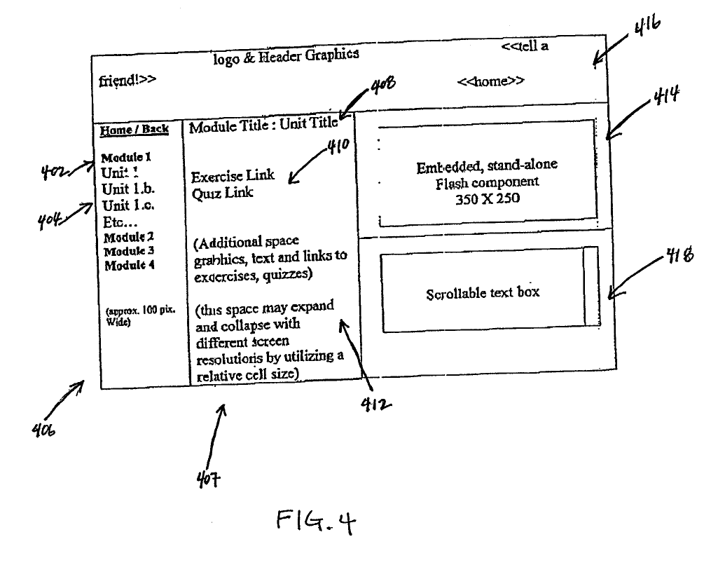

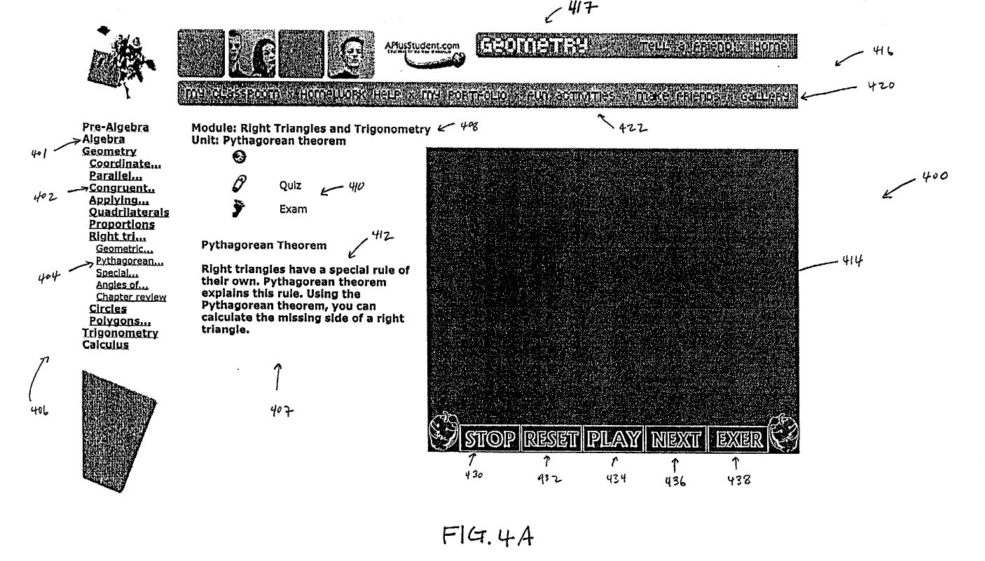

It is from the classroom page 300 that the user is able to access the educational and tutorial material on the website. The user selects the lesson 302 he wishes to study and is linked to a lesson page 400, shown in FIGS. 4 and 4A. FIG. 4 is a schematic view of the lesson page which describes its general layout. FIG. 4A is an example of the lesson page of FIG. 4 showing a pictorial view of an Algebra 1 lesson. It should be understood that although the description of the lesson page 400 is given in part in reference to FIG. 4A, the description is applicable to all the lesson pages, regardless of the school (elementary, middle, or high school) and subject selected.

The lesson page 400 is divided into five sections. The first section is the header 416 which is placed along the top portion of the page and contains various graphics and links of general interest, similar to the headers found on other pages. The header 416 contains the name of the lesson 417, a corporate logo, a “tell a friend” icon and a “home” icon which links the user to the corresponding school page 200, shown in FIG. 2. The header further includes an activity navigation bar 420 which contains all the activity icons 422 that are referenced from the school page 200. The activity navigation bar 420 allows the user to quickly link to another activity, by single clicking on the activity icon 422, without having to backtrack through the previous pages to located the desired activity.

The lesson page 400 has a second section along the left portion of the page which contains a module navigation bar 406. The module navigation bar 406 is drop down menu system which displays the available lessons 401, modules 402, and units 404. The lessons available here are the same lessons that were available on the classroom activity page 300. Modules 402 are categories of subjects falling within a lesson 401, and units 404 are further divided sub-categories falling within the modules 402. FIG. 4A shows an example of the module navigation bar showing Algebra, Geometry, and Trigonometry lessons; the Geometry lesson containing the modules Quadrilaterals, Proportions, and Right Triangles; and the Right Triangles module containing the units Geometric Mean, Pythagorean Theorem, and Special Right Triangles.

The third section is in the center of the page and contains a lesson bulletin area 407. The top of the lesson bulletin contains the name of the module and the unit 408 which is currently selected. Underneath that are links to the exams and quizzes 410 which contain the exercises on the subject matter of the unit selected, and under the links to the exams and quizzes 410 is the text information 412 providing a short summary of the unit selected.

The fourth section along the right portion of the page 400 is an interactive, multimedia tutorial player 414. It is here that graphics, animation, and sound are combined to present the instructional content of the website. The player 414 comes with several buttons which control the playback of the tutorial. The Stop button 430 enables a user to stop the tutorial at any point during its playback. The Reset button 432 enables a user to play the tutorial from its beginning. The Play button enables the user to begin playing the tutorial after it has been stopped. The Next button 436 allows the user to skip to the next part of the tutorial. The Exercise button 438 allows the user to skip the instructional part of the tutorial and to play a short multimedia exercise which tests the instructional portion of the tutorial. Answers are given by either selecting the correct button from a choice of several buttons, or entering the correct answer into a dialogue box.

The fifth section of the page is a scrollable text box 418 and is located underneath the tutorial player 414. The text box (not shown in FIG. 4A) contains text information relating to the lesson being played in the tutorial 414. The box 418 may also contain links to other relevant webpages, and any other helpful information relating to the topic.

The module navigation bar 406 controls the other sections on the page and is designed so that the user can easily and quickly located the exact subject he wishes to study. This enables the user to control the content of the lesson page, by controlling the module navigation bar 406. The module navigation bar 406 displays all the lessons 401, the modules 402 for the lesson selected, and the units 404 for the module 402 selected. As can be seen in FIG. 4A, all the available lessons are constantly displayed, however, only the modules 402 for the lesson selected can be seen. If the Geometry lesson is selected, then only those modules within the Geometry lesson are displayed. If the Algebra lesson is then selected, the modules for the Algebra lesson are displayed, and the modules for the Geometry lesson drop out of sight. Similarly, only those units within the selected module are displayed. If the user selects a different module, then the units associated with the new module are displayed, and those units associated with the old module are removed.

After the user locates the lesson, module, and unit he wishes to study, the lesson bulletin area 407 provides him with the full title 408 to the module and unit selected. The user then has the option of clicking on the exam and quiz links 410 and going to the exercise page 500, or viewing the instructional material on the tutorial player 414.

If the user chooses to view the instructional material, he can select the Play button 434 on the player and view a detailed explanation of the subject matter. The instructional material is broken up into parts, with each part explaining a specific topic related to the unit. In this way, the user can absorb bite-size bits of information without being confused or overwhelmed. Each part of the instructional material is played on the tutorial player, and delivered using graphics, animation and sound. If the user wishes to stop the player, he can select the Stop button 430 on the player 414. He must then select the Play button 434 if he wishes to restart the player and finish the tutorial. If the user already understands the material, he can select the Next button 436 to move on to the next part of the tutorial. At the end of the tutorial, or at any point the user wishes to test himself, he can select the Exercise button 438 which plays an interactive exam testing on the material just covered in the tutorial.

The organization and design of the lesson page 400 provides the user with a convenient and entertaining educational experience. The lesson summary section 405, the tutorial player 414, and the text box 418 work together with the module navigation bar 406 to provide a cohesive and efficient means of delivering information. That is accomplished by means of the drop menu of the module navigational bar 406 which displays the topics contained in the website in a highly organized and concise fashion. The other sections on the lesson page 400 are linked to the module navigational bar 406, and their content is determined by the lesson, module, and unit selected in the navigational bar 406. By simply single clicking on a topic in the module navigational bar, the other sections will automatically display the material associated with the topic selected.

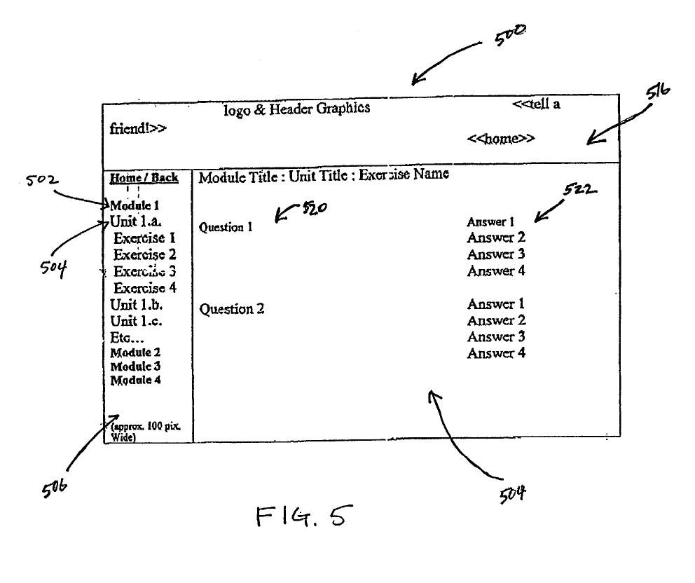

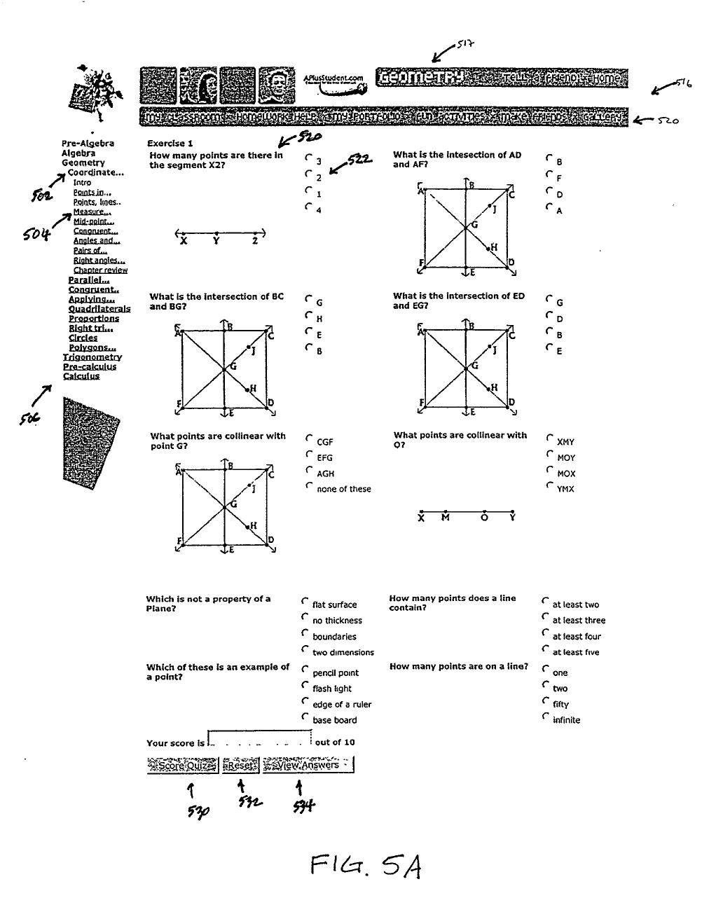

After viewing the instructional material and tutorials on the lesson page 400, the user can test himself by selecting the exam and quiz link 410 in the lesson bulletin area 407. That links him to an exercise page 500, shown in FIGS. 5 and 5A.

The exercise page 500 is divided into three sections. The first section along the top portion of the page is the header 516 and is identical to the header 416 on the lesson page 400. It includes the name of the lesson 517, a corporate logo, a “Tell a Friend” icon, a “Home” icon, and an activity navigation bar 520. The “Tell a Friend” icon, the “Home” icon and the activity navigation bar functions the same as on the lesson page 400.

The second section is a module navigation bar 506 along the left portion of the page 500 and is identical to the module navigation bar 406 on the lesson page 400 and functions in the same manner.

The third section is a question area 504 which encompasses the remainder of the page and contains the individual questions 520 and answers 522. The page contains several questions on the topic being tested. Responses are chosen by either selecting the correct answer from a range of possible answers, or by entering the correct answer into a dialogue box. At the bottom of the question area 504 is a score quiz icon 530, a reset icon 532, and a view answer icon 534.

FIG. 5A shows an example of an exercise page for the module Coordinate Geometry, and unit Points, Lines, and Planes. The page shows several questions with answers being chosen by selecting the correct answer from a possible range of responses. After answering all the questions, the user selects the “Score Quiz” icon 530 and the number of questions he answered correctly is given. He then has the option of selecting either the “Reset” icon 532 which erases all his answers so that he can take the quiz over again, or the “View Answers” icon 534 which reveal the correct answers to the questions. After taking the exam, if the user is satisfied that he understands the subject matter, he can select another module and unit in the module navigation bar 506 to move on to another topic. Doing so displays the lesson page 400 associated with the new module or unit. The user can then view the instructional material in the tutorial player 414 or link to further exercises using the exam and quiz icons 410.

The design and layout of the webpages, particularly the lesson page and the exercise page, allow the user to easily navigate between the various activities of the website. The activity navigation bar at the top of both these pages allows the user to be a single mouse click away from any one of the activities available. In addition, with the module navigation bar, the instructional material contained in the educational website is organized in an easily understandable fashion, and with a few simple mouse clicks, the user can display any of the instructional material.

The activities and the instructional material on the website is designed to be modified and updated. The website can be expanded to include new activities and greater functionality can be added to existing ones. The instructional material, particularly the exams and quizzes, can be periodically updated to include new questions so that previous users can return and retest themselves. The constant updating of information on the website requires an organized and modifiable database system.

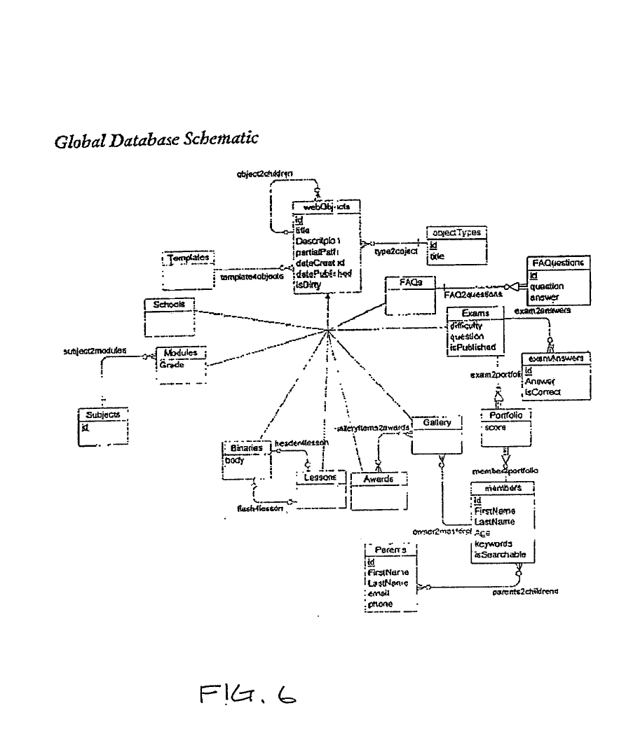

FIG. 6 shows a global database schematic for the present invention showing the organization and inter-relationship of the various databases.

Although only a preferred embodiment is specifically illustrated and described herein, it should be appreciated that many modifications and variations of the present invention are possible in light of the above teachings departing from the spirit and intended scope of the invention.

What is claimed is:

1. An Internet based educational system comprising:
a website having a home webpage containing links to at least one school page, each said school page containing indicia directed to at least one grade and linking to at least one activity page, each said activity page performing tasks related to a purpose of the activity page.

2. The Internet based educational system of claim 1, wherein said at least one school page comprises at least one of a high school page, a middle school page, and an elementary school page.

3. The Internet based educational system of claim 1, wherein said at least one activity page comprises a classroom activity page which provides a plurality of subjects from which to study.

4. The Internet based educational system of claim 3, wherein said classroom activity page contains links to a plurality of lesson pages containing tutorial material on a selected lesson.

5. The Internet based educational system of claim 4, wherein said plurality of lesson pages contains links to a plurality of exercise pages, the exercise pages containing questions and answers on the selected lesson.

6. The Internet based educational system of claim 1, wherein said at least one activity page comprises at least one of a homework activity page, a portfolio activity page, a fun activities activity page, a friends activity page, and a gallery activity page.

7. The Internet based educational system of claim 6, wherein said homework activity page contains a list of frequently asked questions and their answers classified by subject, and further includes an email means to transmit and receive answers to questions.

8. The Internet based educational system of claim 6, wherein said portfolio activity page contains a report of a user's progression through the website.

9. The Internet based educational system of claim 6, wherein said fun activities page contains entertaining activities.

10. The Internet based educational system of claim 6, wherein said gallery activity page contains material uploaded onto the website by a user.

11. An Internet based educational system, comprising:
a website having a classroom activity page for selecting a subject to study and containing links to lesson pages, the lesson pages containing tutorial material associated with a selected lesson; and
wherein each lesson page contains a module navigation bar that accesses a desired topic, and a tutorial player that displays educational material associated with the topic.

12. The Internet based educational system of claim 11, wherein said module navigation bar is a drop menu system for accessing the topic.

13. The Internet based educational system of claim 12, wherein said module navigation bar's drop menu system displays all of the topics at a highest level; and
wherein any level below the highest level displays only those sub-topics which are within a topic selected at a higher level.

14. The Internet based educational system of claim 11, further comprising a header containing an activity navigation bar that links to other activities within the website.

15. The Internet based educational system of claim 11, wherein said tutorial player displays an interactive multimedia presentation relating to the topic.

16. The Internet based educational system of claim 15, wherein said multimedia presentation is broken up into sections, and playback of each section is controlled by buttons associated with the tutorial player.

17. The Internet based educational system of claim 11, further comprising a lesson bulletin displaying a summary of the selected topic, and links to exercises concerning the selected topic.

18. The Internet based educational system of claim 17, wherein a topic is selected using the module navigation bar, and the selected topic controls the display of the tutorial player and the lesson bulletin.

19. The Internet based educational system of claim 18 further comprising a text box containing information on the topic selected in the module navigation bar.

20. An Internet based educational system, comprising:
a website having a lesson page containing tutorial material associated with a selected lesson;
wherein the lesson page contains a module navigation bar that accesses a desired topic, a tutorial player that displays educational material associated with the topic, a lesson bulletin displaying a summary of the selected topic and a text box which contains information on the selected topic; and
wherein the topic is selected in the module navigation bar by single clicking on said topic.

21. An Internet based educational system comprising:
a website having a lesson webpage containing tutorial material associated with a selected lesson; and
wherein the lesson webpage contains links to exercise pages, the exercise pages containing questions and answers on the selected lesson.

22. The Internet based educational system of claim 21, wherein the exercise pages contain a module navigation bar and an exercise display area, the exercise display area containing the questions on the selected lesson.

23. The Internet based educational system of claim 22, wherein said module navigation bar is a drop menu system for accessing a topic.

24. The Internet based educational system of claim 23, wherein said drop menu system of the module navigation bar displays all of the topics at a highest level; and
wherein any level below the highest level displays only those sub-topics which are within a topic selected at a higher level.

25. The Internet based educational system of claim 21, wherein said questions are answered by choosing a correct response from several choices or by entering a correct answer into a dialogue box.

26. The Internet based educational system of claim 25, wherein said exercise display area contains a score quiz icon for retrieving the number of correct responses given, and a view answers icon for displaying the correct answer to the questions.

27. The Internet based educational system of claim 21, further comprising a header containing an activity navigation bar that links to other activity pages within the website.

28. A method of using an Internet based educational system comprising the steps of:
providing a home page having at least one school icon linking to at least one school page;
selecting a school icon and being linked to a school page, wherein the school page has at least one activity icon linking to at least one activity page; and
selecting an activity icon and being linked to an activity page.

29. The method of using an Internet based educational system of claim 28, further comprising the steps of:
providing a school page having a classroom activity icon;
selecting the classroom activity icon and being linked to a classroom page for selecting a subject, the classroom page having a plurality of lesson icons; and
selecting a lesson icon and being linked to a lesson page containing tutorial material related to the selected lesson.

30. The method of using an Internet based educational system of claim 28, further comprising the steps of:
providing an activity page having a header with an activity navigation bar having activity icons for linking to other activities; and
selecting an activity icon and being linked to the activity page.

31. A method of using an Internet based educational system comprising the steps of:
providing a lesson page containing a module navigation bar for accessing a desired topic and a tutorial player that displays educational material associated with the desired topic.

32. The method of using an Internet based educational system of claim 31, further comprising the steps of:
providing the module navigation bar with a drop menu system where the topics at a highest level are constantly displayed; and
selecting a topic at the highest level and revealing sub-topics within the topic selected while other sub-topics are not displayed.

33. The method of using an Internet based educational system of claim 32, further comprising the step of selecting a sub-topic and displaying the topics within the selected sub-topic while other topics are not displayed.

34. The method of using an Internet based educational system of claim 31, further comprising the step of viewing an interactive multimedia presentation in the tutorial player using playback buttons on the tutorial player.

35. The method of using an Internet based educational system of claim 31, further comprising the steps of:
providing the lesson page with a lesson bulletin having exercises icons; and
selecting an exercise icon and being linked to an exercise page containing a plurality of questions and answers.

36. The method of using an Internet based educational system of claim 35, further comprising the step of answering the questions by selecting a correct response from several choices or by entering a correct answer into a dialogue box.

37. The method of using an Internet based educational system of claim 35, further comprising the step of selecting a score quiz icon to reveal the number of correct answers given.

38. The method of using an Internet based educational system of claim 35, further comprising the step of selecting a view answers icon to reveal the correct answers to the questions.

39. The method of using an Internet based educational system of claim 35, further comprising the steps of:
providing the lesson page with a text box containing information on the topic selected in the module navigation bar.

40. A method of using an Internet based educational system comprising the steps of:
providing a lesson page having a plurality of section comprising a module navigation bar for accessing a desired topic, a tutorial player that displays educational material associated with the topic, a lesson bulletin displaying a summary of the topic and a text box containing information on the topic;
clicking on the topic in the module navigation bar governs the content of the other sections of the module navigation bar.
